(19) United States
(12) Patent Application Publication
(10) Pub. No.: US 2024/0127140 A1
(43) Pub. Date: Apr. 18, 2024

(54) Qualification-Based Task Management

(71) Applicant: Oracle International Corporation, Redwood Shores, CA (US)

(72) Inventors: Robert St. Pierre, Campbell, CA (US); Mark Pearson, Redwood Shores, CA (US)

(73) Assignee: Oracle International Corporation, Redwood Shores, CA (US)

(21) Appl. No.: 18/359,930

(22) Filed: Jul. 27, 2023

Related U.S. Application Data
(60) Provisional application No. 63/416,504, filed on Oct. 15, 2022.

(51) Int. Cl. G06Q 10/0631; G06Q 10/0633; G06Q 10/20

(52) U.S. Cl. CPC G06Q 10/063112; G06Q 10/063114; G06Q 10/0633; G06Q 10/20

(57) ABSTRACT

Techniques for implementing a qualification-based task management system in a work environment are disclosed. When a user logs in to a work center terminal, a system identifies a set of pending tasks that need to be completed. The system filters the tasks available to the user based on the user's qualifications and the equipment present at the work center. When the system identifies a task for which there is not a set of users with matching qualifications, the system applies a machine learning model to the task parameters to identify candidate users or recommended qualifications for performing the task.

### INCORPORATION BY REFERENCE; DISCLAIMER

The following application is hereby incorporated by reference: application no. 63/416,504, filed Oct. 15, 2022. The applicant hereby rescinds any disclaimer of claims scope in the parent application(s) or the prosecution history thereof and advises the USPTO that the claims in the application may be broader than any claim in the parent application(s).

### TECHNICAL FIELD

The present disclosure relates to work center resource network integration. In particular, the present disclosure relates to operations and user interfaces for reordering sets of tasks in a work center.

### BACKGROUND

In physical facilities, such as manufacturing plants, workers at many different work stations interact with equipment to perform tasks on materials, such as product components. Many different events may result in sub-optimal performance of a manufacturing facility. For example, a drop in a worker's productivity may result in delays to subsequent tasks and failure to deliver products on time. Equipment breakdown may take a work center out of action for a time, resulting in delays to any tasks that rely on the work center. Tracking multiple different performance metrics across the manufacturing facility may be a complex data gathering and analysis process. Identifying a source of a problem—whether a fault or a failure to meet specified performance metrics—can be even more challenging. Determining how to re-order tasks performed by workers to improve performance metrics based on the identified problems adds yet another layer of complexity. A task manager may not have a clear idea of how rearranging tasks will affect other tasks, or how effective the changes would be to improve performance metrics the task manager is most concerned about. For example, if a machine breaks down, a task manager can send materials to another work center to have another worker perform a task. However, the task manager may not be able to predict how effective the change would be to overall equipment utilization, worker utilization, or on-time deliveries. The task manager may also not be able to predict the repercussions a task reordering may have on additional tasks at other work centers.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIG. 2 illustrates an example set of operations for multi-layer forecasting of computational workloads in accordance with one or more embodiments;

FIG. 3 illustrates an example set of operations for training a machine learning model to recommend alternate task schedules in accordance with one or more embodiments;

FIGS. 4A and 4B illustrate an example embodiment for implementing qualification-based task management; and

FIG. 5 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

1. GENERAL OVERVIEW

2. SYSTEM ARCHITECTURE

3. USER-QUALIFICATION BASED TASK MANAGEMENT

4. TRAINING A MACHINE LEARNING MODEL

5. EXAMPLE EMBODIMENT

6. COMPUTER NETWORKS AND CLOUD NETWORKS

7. MISCELLANEOUS; EXTENSIONS

8. HARDWARE OVERVIEW

### 1. GENERAL OVERVIEW

One or more embodiments provide a qualification-based task management work center that adapts to a user that logs into a workstation (or computer) at the work center. The workstation identifies a set of pending tasks that need to be completed. Each particular pending task of the set of pending tasks may be completed by any user, of a set of users, with the qualifications to complete the particular pending task. When a particular user of the set of users logs into the workstation, a system analyzes the qualifications of the particular user to determine and present a subset of the set of pending tasks that can be performed by the user. For example, one user may log in to a work center terminal and be presented with a set of three tasks available to be performed using equipment available at the work center. Another user may log into the same terminal and be presented with a different set of three tasks to be performed, based on a task management platform determining the users have different qualifications. For example, one user may be certified to operate a piece of equipment, while another user is not certified to operate the piece of equipment.

One or more embodiments make a new task available to a user or pool of users based on a particular set of recommended user qualifications corresponding to the new task. For example, when the system detects a fault in a work environment, the system determines the recommended qualifications for addressing the fault. If the system detects a qualifications match between recommended user qualifications for a task and user qualifications of one or more users, the system makes a corresponding task available to the users when the users log in to a work center terminal. If a task requires two or more users, the system may notify the respective users at their respective work centers. For example, one user may initiate a task requiring two separate users to complete. Upon detecting the user initiating the task, the system may notify another user that a task will be available for completion. If no task exists to address the particular fault, the system may generate a new task. The system determines the recommended user qualifications, equipment, and materials to complete the task. The system may identify dependencies among tasks. When one user completes one task, the system may make a dependent task available to a pool of users.

According to one or more embodiments, when the system identifies a task for which the system does not detect a match between recommended qualifications and user qualifications, the system applies a set of task parameters to a machine learning model to identify a user, or a pool of candidate users, to whom to assign the task. For example, the machine learning model may learn a relationship between a task description and terms in a user profile, historical tasks performed by users, education information associated with a user, or a user's training. Instead of a user's name or identification information, the machine learning model may recommend user qualifications for performing a task. For example, a system may determine that a machine “M100” requires maintenance. However, no user may have qualifications including the “M100” model. For example, searching user experience, training, and work history in a database may return no results for “M100.” The machine learning model may learn during training that a user qualified to perform maintenance on a “P300” model has a high success rate servicing “M100” models. Accordingly, the machine learning model may generate a recommended qualification including the term “P300.” When the system searches the database for “P300,” the system identifies at least three workers who may be qualified to perform maintenance on the M100 model. Accordingly, the system adds a new task to a task management platform to perform maintenance on the M100 machine including the user qualification “P300 maintenance.” As another example, the machine learning model may learn that a particular manager relies on a particular user to perform maintenance on each machine in the manager's organization with a high success rate. Accordingly, the machine learning model may generate a recommended user qualification for a particular task including either the user's name or other identifying information, such as “Section B, employee type: service technician.”

One or more embodiments described in this Specification and/or recited in the claims may not be included in this General Overview section.

### 2. SYSTEM ARCHITECTURE

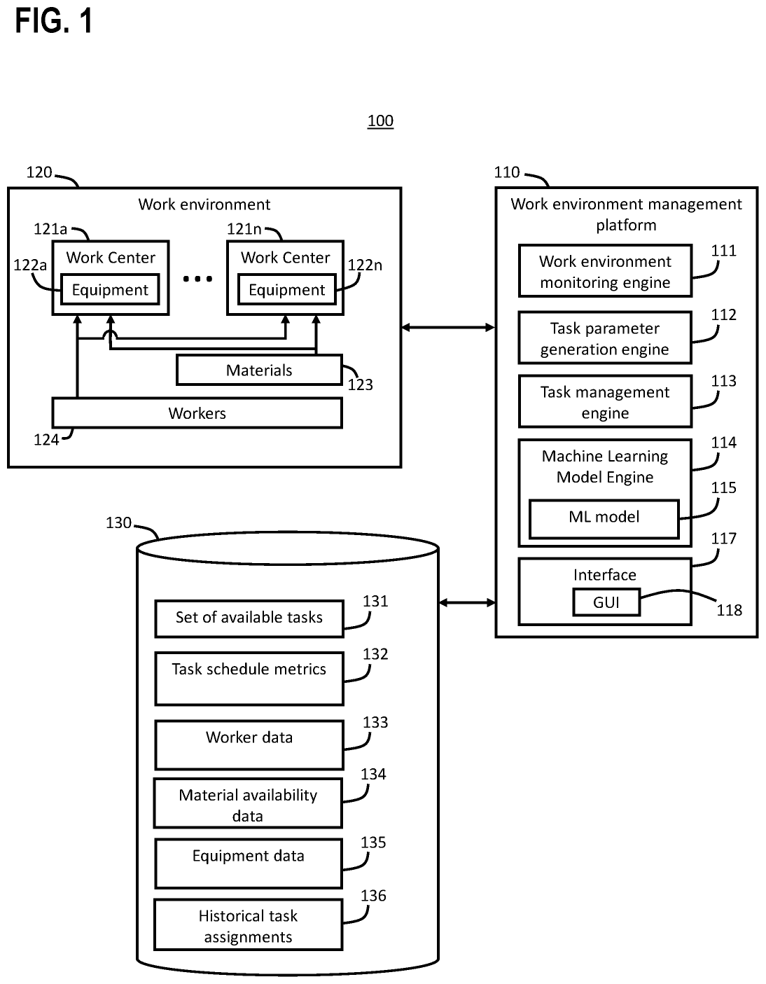

FIG. 1 illustrates a system 100 in accordance with one or more embodiments. As illustrated in FIG. 1, system 100 includes a work environment management platform 110 and a data repository 130. The work environment management platform 110 monitors and manages operations in a work environment 120. As an example, a work environment may be a manufacturing facility. The facility includes work centers 121a-121n. Each work center includes a set of equipment 122a-122n. One work center may be a component assembly work center. At a component assembly work center, workers may assemble components from materials 123. Components assembled at one work center may be the materials required to perform additional tasks at another work center. Another work center may be a component testing work center. Another work center may be a quality assurance work center. One or more workers 124 may be assigned to work at a particular work center 121a-121n. When a worker 124 logs in to a terminal at a work center, the terminal identifies the tasks to be performed by the worker 124. The terminal may further grant and deny access to equipment 122a-122n at the work center, according to the worker's assigned tasks and authorization level.

According to one or more embodiments, the work environment 120 includes work centers 121a-121n associated with various pieces of equipment 122a-122n. A work center may include a user terminal, testing equipment, manufacturing equipment (e.g., saws, drills, etc.) or any other equipment for manufacturing, assembling, and testing components. Different types of equipment require different qualifications for workers 124 to handle the equipment. One or more embodiments analyze worker qualifications to manage the worker's access to equipment associated with a work center.

In an embodiment, the work environment management platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

The work environment management platform 110 includes a work environment monitoring engine 111 to monitor attributes of the work environment 120. The work environment monitoring engine 111 may monitor worker status data, equipment status data, materials status data, and other work environment data. Monitoring worker status data may include detecting a worker log in/log out, detecting a selection by a worker at a work center terminal to being or pause a task or indicate a particular task has been completed, and detecting notifications requesting particular workers at particular work centers in the work environment 120. Monitoring equipment status data may include monitoring whether a piece of equipment is operational or out of service (e.g., in a fault state), monitoring the calibration status of equipment, and monitoring whether equipment is in use and for how long. Monitoring materials data may include detecting a location of materials in the work environment 120 and detecting a quantity of materials available in the work environment.

Monitoring the work environment includes detecting anomalies and faults in the work environment. For example, the work environment monitoring engine 111 may receive a notification from a piece of work equipment 122a at work center 121a that the equipment is not functioning correctly. In addition, the work environment monitoring engine 111 may monitor performance statistics of workers 124 to determine that a particular worker at work center 121n is not performing tasks at an expected rate, resulting in delays in the work environment 120.

A task parameter generation engine 112 identifies requirements for new tasks and generates parameters for the new tasks. For example, the task parameter generation engine 112 may determine that a fault in equipment 112a requires: (a) used of equipment 112a and test equipment (not shown), (b) an expert with particular qualifications, and (c) particular materials 123, such as spare parts for the equipment 112a. The task parameter generation engine 112 generates a set of parameters for a new task, including minimum user qualifications required to perform the task.

A task management engine 113 generates a task based on the task parameters. The task management engine 113 adds the task to a set of tasks available to workers 124 and work centers 121a-121n to be performed in the work environment 120. The task management engine 113 detects a worker login to a work center 121a-121n. The task management engine 113 analyzes (a) worker data 133, including worker qualifications, (b) equipment data 135 corresponding to equipment available at the work center 121a where the worker logged in, and (c) material availability data 134 of material available at the work center 121a where the worker logged in. Based on the worker data 133, equipment data 135, and material availability data 134, the task management engine 113 presents to a worker at the work center 121a a sub-set of tasks from among the set of available tasks 131 to be performed by the worker at the work center 121a. In one or more embodiments, the task management engine 113 generates the sub-set of tasks taking into account a dependency among tasks. For example, repairing a piece of faulty equipment 122a may include two tasks performed by two different experts, with one task following the other. When the second expert logs in to work center 121a, the task management engine 113 determines whether the first task in the set of two sequential tasks has been completed by another expert. If so, the task management engine 113 presents the second task to the second expert to be performed. If the first task has not yet been completed, the task management engine 113 may refrain from presenting the second task to the second expert. In addition, or in the alternative, the task management engine 113 may generate a notification to one or both of the first expert and the second expert indicating the first task has not yet been completed.

In one or more embodiments, the task management engine 113 applies a machine learning model 115 to a set of task parameters to assign a particular task to a particular worker or set of workers 124. For example, the work environment monitoring engine 111 may encounter a fault that does not match any prior fault. Accordingly, the task parameter generation engine 112 may generate a set of task parameters that does not match existing tasks. For example, in a work environment 120 that manufactures medical equipment, a fault may include among its parameters an unknown liquid in a particular piece of equipment 122n. The task parameter generation engine 112 may generate a set of task parameters including “liquid analysis and clean-up.” However, there may be no record of a qualification associated with “liquid analysis and clean-up” among the worker qualifications information in the worker data 133. Accordingly, a machine learning model may select a “best fit” predicted worker or set of workers based on a set of input features. The input features may include, for example: worker qualifications and historical records of which workers completed tasks for which there was also no matching task or qualified worker. Examples of worker qualifications include historical experience that includes working with liquids in other fields or applications than in medical manufacture machines, fields of study, training completed, estimated times to complete tasks, and a metric of a worker's self-perceived workload. According to one embodiment, generating the “best fit” set of workers includes learning, through training, qualifications to include in a task. For example, the machine learning model may learn through training that workers with qualifications including “hydraulic theory” have been utilized in the past to perform tasks dealing with water, oil, and other fluids in a work environment. The machine learning model may generate a set of recommended user qualifications including “hydraulic(s).”

According to one or more embodiments, the system considers performance metrics in the work environment 120 to determine whether to assign a task to a worker or allow a pool of workers to access a task. For example, if two workers have a set of qualifications that would allow both workers to perform a task, and if assigning the task to a first worker would result in a utilization rate increase of 5% in the work environment 120 compared to the second worker, the system may assign a task to the first worker. Assigning the task to the worker or pool of workers includes presenting the task together with a set of tasks available to the worker when the worker logs in to a work center.

According to one or more embodiments, a manager or administrator may access the work environment management platform 110 via an interface 117 to view task pools, task assignments, and worker qualifications. In one or more embodiments, interface 117 refers to hardware and/or software configured to facilitate communications between a user and the work environment management platform 110. Interface 117 renders user interface elements and receives input via user interface elements. Examples of interfaces include a graphical user interface (GUI) 118, a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 117 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 117 is specified in one or more other languages, such as Java, C, or C++.

According to one embodiment, the work environment platform 110 displays a geographical representation of a work environment in the GUI 118. The work environment platform 110 may overlay visual elements representing performance metrics on top of regions in the geographical representation of the work environment. For example, the work environment management platform 110 may display in the GUI 118 boxes representing locations in a manufacturing facility corresponding to separate work centers. The platform 110 may overlay, onto the boxes, icons representing a particular numerical value representing the value of the performance metric associated with the work center. For example, a work center characterized by a 95% efficiency level may be overlaid by a relatively long column icon or a green icon. A work center character characterized by a 50% efficiency level may be overlaid by a relatively short column icon or a red icon.

A machine learning engine 114 trains a machine learning model 115 to predict a worker, set of workers, or set of worker qualifications associated with particular tasks. In some examples, one or more elements of the machine learning engine 114 may use a machine learning algorithm to train the machine learning model 115 using historical task assignments 136 of tasks to workers and/or experts. A machine learning algorithm is an algorithm that can be iterated to learn a target model f that best maps a set of input variables to an output variable, using a set of training data. A machine learning algorithm may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging, random forest, boosting, backpropagation, and/or clustering.

In an embodiment, a set of training data includes datasets and associated labels. The datasets are associated with input variables (e.g., worker qualifications, task parameters, historical records of tasks performed by workers, a quality score associated with a task performed by a worker) for the target model f. The associated labels are associated with the output variable (e.g., whether a worker performed a task) of the target model f. The training data may be updated based on, for example, feedback on the accuracy of the current target model f. Updated training data is fed back into the machine learning algorithm, which in turn updates the target model f.

A machine learning algorithm generates a target model f such that the target model f best fits the datasets of training data to the labels of the training data. Additionally, or alternatively, a machine learning algorithm generates a target model f such that when the target model f is applied to the datasets of the training data, a maximum number of results determined by the target model f matches the labels of the training data.

In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 6, titled “Computer Networks and Cloud Networks.”

In one or more embodiments, a data repository 130 is any type of storage unit and/or device (e.g., a file system, database, collection of tables, or any other storage mechanism) for storing data. Further, a data repository 130 may include multiple different storage units and/or devices. The multiple different storage units and/or devices may or may not be of the same type or located at the same physical site. Further, a data repository 130 may be implemented or may be executed on the same computing system as the work environment management platform 110. Alternatively, or additionally, a data repository 130 may be implemented or executed on a computing system separate from the work environment management platform 110. A data repository 130 may be communicatively coupled to the work environment management platform 110 via a direct connection or via a network.

Information describing a set of tasks available to be performed in a work environment 120, task schedule metrics 132, worker data 133, material availability data 134, equipment data 135, and historical task assignments to workers 136 may be implemented across any of components within the system 100. However, this information is illustrated within the data repository 130 for purposes of clarity and explanation.

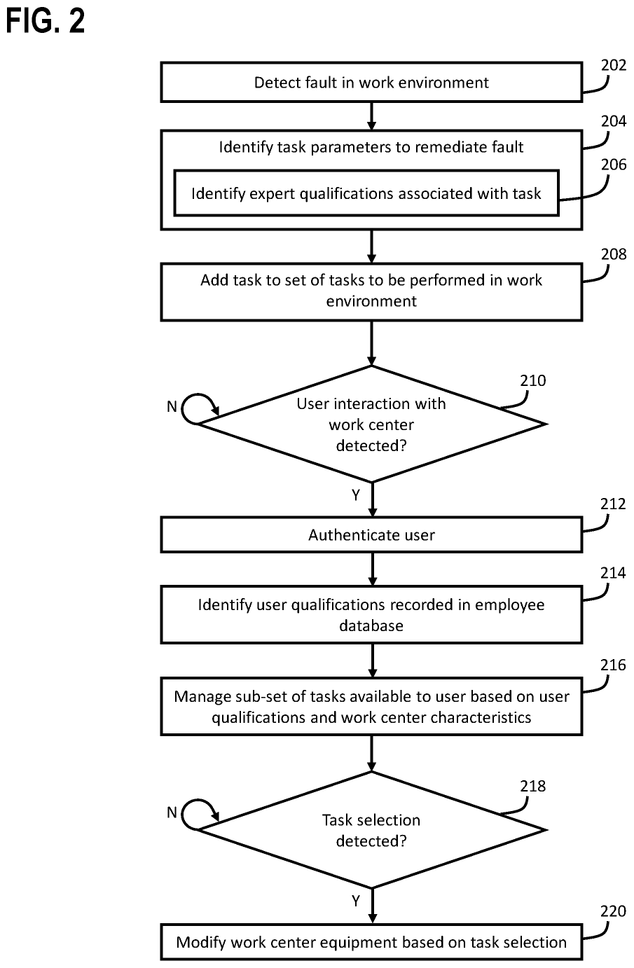

In one or more embodiments, the work environment management platform 110 refers to hardware and/or software configured to perform operations described herein for recommending and implementing task schedules for a work environment. Examples of operations for recommending and implementing task schedules for a work environment are described below with reference to FIG. 2.

### 3. USER-QUALIFICATION BASED TASK MANAGEMENT

FIG. 2 illustrates an example set of operations for reordering of work center tasks in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

A system detects a fault in a work environment (Operation 202). The system may receive signals from equipment in a work environment indicating an equipment malfunction, a flaw in a component made by the equipment, or a maintenance requirement for the equipment. In addition, or in the alternative, the system may receive signals from a work environment monitoring platform that one or more users are unavailable or are performing below a specified standard.

The system identifies task parameters to remediate the detected fault (Operation 204). Task parameters include: equipment that is in a fault state, equipment needed to remediate the fault, materials needed to remediate the fault, and user qualifications required to remediate the fault. The system may identify expert qualifications associated with the task (Operation 206). For example, an expert may be a user with a specific area of specialty, such as component assembly, operation of a particular machine or piece of equipment in a work environment, diagnostics of a particular piece of equipment, and repair of the equipment. While FIG. 2 illustrates an embodiment in which the system detects a fault and identifies task parameters associated with the fault, one or more embodiments present sets of tasks to users without having detected any fault in a work environment.

Based on the task parameters, the system generates a new task to add to a set of tasks to be performed in the work environment (Operation 208). The system stores a task as a file including (a) operations to be performed by a user, (b) equipment on which to perform the operations, and (c) materials used to perform the operations. The system stores metadata with the task specifying user qualifications required to access the task. In addition, or in the alternative, the system may store a set of users with qualifications that match the qualifications required to perform the task.

According to one or more embodiments, the system utilizes a machine learning model to generate the new task, or to identify a user or set of users to associate with the task. For example, a system may compare the task parameters to stored user qualifications, availability, and work centers at which users may be assigned. If there is a match between the task requirements and user qualifications for an available user, the system may assign the task to the user. Similarly, if there is a match between the task requirements and a set of users, the system may enable any one of the set of users to perform the task. For example, the system may present the first user to log in with the task in a user terminal, as discussed below. However, if the system determines there is not a match between task requirements and user qualifications for any available user, the system may apply a machine learning model to a set of input features, including user qualifications, user availability, equipment data, and materials data to recommend a particular user for a particular task.

Upon generating the task and assigning the task to a user or set of users, the system determines whether a user has interacted with a user terminal in a work center in the work environment (Operation 210). In one or more embodiments, a user logs into a terminal at a work center to obtain a set of tasks that the user may perform at the work center. Logging in may include manually entering a user identification, swiping a user identification card, or detecting a user's identification via a facial recognition application.

The system authenticates the user (Operation 212). Authentication includes confirming that the user is permitted to access one or more pieces of equipment at the work center where the user logged in.

The system accesses a database to retrieve the user's qualifications (Operation 214). The qualifications may be defined as a function of one or more of: certifications, work history, training, education, and any other expertise recorded in the database.

According to one embodiment, based on determining that the user's qualifications match the qualifications required for the new task, the system presents the new task for the user to select on a user terminal. The new task may be one task among a set of tasks available to the user to perform at the terminal. The system may rank tasks according to urgency and/or dependency. For example, if the user must perform a maintenance task on a piece of equipment prior to using the equipment to make a component, the system presents a maintenance task as a priority task that must be performed prior to a component-manufacture task.

According to one example, a user at one work center may have qualifications to perform a task at another work center. The task may be to perform repairs or maintenance at the other work center. Alternatively, the task may be to use equipment and/or materials available at the other work center that may not be available at the original work center. Alternatively, the user's original work center may be needed for a different task to be performed by a different user, and the user may be able to perform tasks at another work center while the user's original work center is being used for a different task. When the user logs in at a first work center, the system may provide the user with a notification to proceed to the second work center to log in at the second work center and to perform a task at the second work center.

As discussed above, while one or more embodiments encompass identifying a user with qualifications to remediate a fault, one or more additional or alternative embodiments identify a user with qualifications to perform a task that may not involve a fault in the work environment.

As another example, the system may filter a set of tasks assigned to the work center based on the user's qualifications. For example, twenty tasks may be assigned to be completed at the work center. However, the user may only have the qualifications to handle equipment associated with ten of the tasks. The system may present only the ten tasks for the user to perform. The system may display a user interface element associated with the remaining tasks indicating that further qualifications is required. In addition, or in the alternative, the system may display a user interface element associated with the remaining tasks to notify a supervisor or other authorized employee to come to the user's work center to assist with performance of the tasks for which the user does not have the qualifications.

According to one or more embodiments, the system may identify a set of five tasks for which two workers have the appropriate qualifications, a set of six task for which three workers have the appropriate qualifications, and a set of eight tasks for which four workers have the appropriate qualifications. The system may present sets of tasks to the respective workers according to: the uniqueness of the worker's qualifications (e.g., if all four workers can perform one task, but only one worker may perform a second task, the system assigns the second task to the one worker before assigning the first task to the one worker) and a priority of the task. The system may assign a priority to different tasks according to predefined criteria. Alternatively, a manager or administrator may assign priorities to particular tasks.

According to another example, the system may generate a user interface element selectable by the user to complete training and/or education to qualify for completing one or more tasks associated with the work center. For example, a work center may have three pieces of equipment for completing tasks. Based on detecting that the user does not have the qualifications to use one of the pieces of equipment, the system may display a user interface element on a work center GUI. Upon selection of the user interface element, the system may initiate a qualification program, such as a video, text, or application to allow the user to become qualified in one or more pieces of equipment.

The system detects whether a user has selected a task (Operation 218). If the user selects a task, the system modifies work center equipment based on the selected task. The system may record a task start time and a task end time. The system may turn on equipment, unlock equipment and/or materials, and modify a display of a user terminal to provide information for performing the task. The information may include step-by-step instructions, diagrams, deadline information, or any other information associated with the task. In one or more embodiments, the system generates a notification to another user when a task is initiated. For example, the system may identify a dependent task that cannot be performed prior to its parent task. When a user selects the parent task on the user terminal, the system may generate a notification to a user or set of users associated with the dependent task that the parent task has been initiated.

Based on detecting the user selection of a task to be performed, the system modifies one or more pieces of work center equipment (Operation 220). For example, the system may interface with one or more pieces of equipment located at the work center to manage the user's access to the equipment. For example, if the user has qualifications to operate a particular saw, the system may electronically unlock the saw for operation by the user. If the user does not have qualifications to operate a forklift, the system may electronically lock the forklift to prevent use of the forklift by the user. Likewise, if a user has qualifications to use a particular medical device, the system may transmit an authorization message to the medical device to allow the user to operate the medical device.

As another example, based on determining that a user does not have qualifications to operate a particular piece of equipment without supervision, the system may notify a user's supervisor when the system identifies a task that requires supervision. For example, the system may generate a notification at the supervisor's work center. As another example, the system may illuminate an alert-type light at the user's work center.

According to one embodiment, the system tracks the time that a user spends operating equipment. The system may store the tracked time in the employee database. The tracked time may be used towards completion of qualification with particular equipment or to demonstrate a particular level of experience the user has with the equipment.

### 4. TRAINING A MACHINE LEARNING MODEL

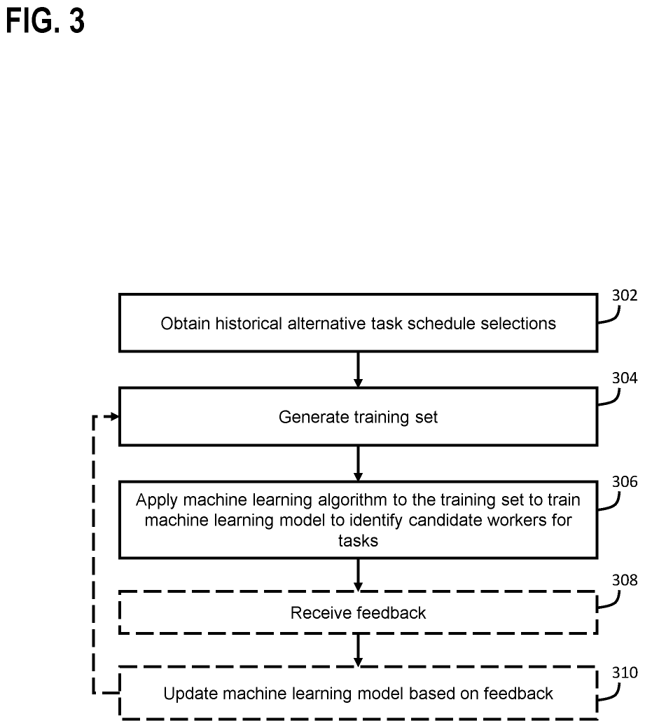

FIG. 3 illustrates an example set of operations for training a machine learning model to generate recommendations for candidate users to perform tasks, in accordance with one or more embodiments. For example, when a system identifies a task to be performed that includes recommended user qualifications that do not match the qualifications of users in a database, the system may apply the machine learning model to the task parameters to identify one or more candidate users to perform the task. A system obtains historical user assignments for tasks (Operation 302). Historical task assignments include determining which users have performed specified tasks. The historical data includes information about the task performed, such as equipment used to perform the task, work centers in a work environment where the task was performed, materials used to perform the task, user qualifications of the users who performed the tasks, supervisors of users, success rates (e.g., whether a task was successfully completed), and recidivism rates (e.g., whether task resolution actually closed the task, or whether the task had to be re-performed within a specified period of time).

Once the various data (or subsets thereof) are identified in Operation 302, the system generates a set of training data (operation 304). Training data may include (a) a set of tasks assigned to a respective set of users and/or work centers in a work environment, and (b) for each set of tasks, at least one label. Examples of labels include: user qualifications of the users who performed the tasks, equipment used to perform the task, work centers in a work environment where the task was performed, materials used to perform the task, information identifying supervisors, managers, or other employees associated with the task, and performance metrics, such as a time spent performing the task.

According to one embodiment, the system obtains the historical data and the training data set from a data repository storing labeled data sets. The training data set may be generated and updated by a work environment management platform. Alternatively, the training data set may be generated and maintained by a third party.

In some embodiments, generating the training data set includes generating a set of feature vectors for the labeled examples. A feature vector for an example may be n-dimensional, where n represents the number of features in the vector. The number of features that are selected may vary depending on the particular implementation. The features may be curated in a supervised approach or automatically selected from extracted attributes during model training and/or tuning. Example features include performance metrics for a task, an identify of a worker who performed the task, worker qualifications, and worker schedules. In some embodiments, a feature within a feature vector is represented numerically by one or more bits. The system may convert categorical attributes to numerical representations using an encoding scheme, such as one-hot encoding, label encoding, and binary encoding. One-hot encoding creates a unique binary feature for each possible category in an original feature. In one-hot encoding, when one feature has a value of 1, the remaining features have a value of 0. For example, if a task attribute has ten different categories, the system may generate ten different features of an input data set. When one category is present (e.g., value “1”), the remaining features are assigned a value “0.” According to another example, the system may perform label encoding by assigning a unique numerical value to each category. According to yet another example, the system performs binary encoding by converting numerical values to binary digits and creating a new feature for each digit.

The system applies a machine learning algorithm to the training data set (Operation 306). The machine learning algorithm analyzes the training data set to identify data and patterns that indicate relationships between input features and candidate users for performing tasks. According to one embodiment, recommending users for performing tasks includes recommending particular user qualifications rather than the identify of a particular user. For example, if a particular task parameter includes a particular piece of equipment and a particular set of operations to be performed on the equipment, and if no user's profile includes reference to the particular set of operations, the machine learning model's recommendation may comprise a description of user qualifications that may best match the particular equipment and the particular operations. Types of machine learning models include, but are not limited to, linear regression, logistic regression, linear discriminant analysis, classification and regression trees, naïve Bayes, k-nearest neighbors, learning vector quantization, support vector machine, bagging and random forest, boosting, backpropagation, and/or clustering.

In some embodiments, the system iteratively applies the machine learning algorithm to a set of input data to generate an output set of labels, compares the generate labels to pre-generated labels associated with the input data, adjusts weights and offsets of the algorithm based on an error, and applies the algorithm to another set of input data.

In some embodiments, the system compares the labels estimated through the one or more iterations of the machine learning model algorithm with observed labels to determine an estimation error. The system may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted. In some embodiments, the system determines whether to adjust the weights and/or other model parameters based on the estimation error. Adjustments may be made until a candidate model that minimizes the estimation error or otherwise achieves a threshold level of estimation error is identified.

In some embodiments, the system selects machine learning model parameters based on the estimation error meeting a threshold accuracy level. For example, the system may select a set of parameter values for a machine learning model based on determining that the trained model has an accuracy level for predicting workers to be assigned to tasks of at least 98%.

In some embodiments, the system trains a neural network using backpropagation. Backpropagation is a process of updating cell states in the neural network based on gradients determined as a function of the estimation error. With backpropagation, nodes are assigned a fraction of the estimated error based on the contribution to the output and adjusted based on the fraction. In recurrent neural networks, time is also factored into the backpropagation process. As previously mentioned, a given set of training data includes tasks that were historically performed by users and corresponding attributes (such as user qualifications, equipment used or operated on, and a time required to complete the task). Each task assigned to a worker may be processed as a separate discrete instance of time. For instance, a data set may include performed tasks c₁, c₂, and c₃ corresponding to times t, t+1, and t+2, respectively. Backpropagation through time may perform adjustments through gradient descent starting at time t+2 and moving backward in time to t+1 and then to t. Further, the backpropagation process may adjust the memory parameters of a cell such that a cell remembers contributions from previous expenses in the sequence of expenses. For example, a cell computing a contribution for e₃ may have a memory of the contribution of e₂, which has a memory of e₁. The memory may serve as a feedback connection such that the output of a cell at one time (e.g., t) is used as an input to the next time in the sequence (e.g., t+1). The gradient descent techniques may account for these feedback connections such that the contribution of set of tasks to a cell's output may affect the contribution of the set of tasks in the cell's output. Thus, the contribution of c₁ may affect the contribution of c₂, etc. Accordingly, the model may learn a relationship between sequences of tasks performed by a user.

Additionally, or alternatively, the system may train other types of machine learning models. For example, the system may adjust the boundaries of a hyperplane in a support vector machine or node weights within a decision tree model to minimize estimation error. Once trained, the machine learning model may be used to recommend users or sets of users to perform tasks.

In examples of supervising ML algorithms, the system may obtain feedback on the whether a particular user or set of users should be assigned to a particular task (Operation 308). The feedback may affirm that a particular user should be assigned to a particular task. In other examples, the feedback may indicate that a particular user should not be assigned to a particular task. Based on the feedback, the machine learning training set may be updated, thereby improving its analytical accuracy (Operation 310). Once updated, the system may further train the machine learning model by optionally applying the model to additional training data sets.

In one or more embodiments, a system provides a user with a set of one or more tasks the user may perform when the user logs in to a work center terminal. The system presents the user with tasks that match the user's qualifications. If the system identifies a task for which there are no matches to any user qualifications, a machine learning model recommends one or more user qualifications that may be used by the system to provide the task to at least one user. In other words, the machine learning model recommends at least one user qualification of at least one user in a database of available users. According to an alternative embodiment, the machine learning model recommends a user by an identifier, such as a user name or class of users.

### 5. EXAMPLE EMBODIMENT

A detailed example is described below for purposes of clarity. Components and/or operations described below should be understood as one specific example which may not be applicable to certain embodiments. Accordingly, components and/or operations described below should not be construed as limiting the scope of any of the claims.

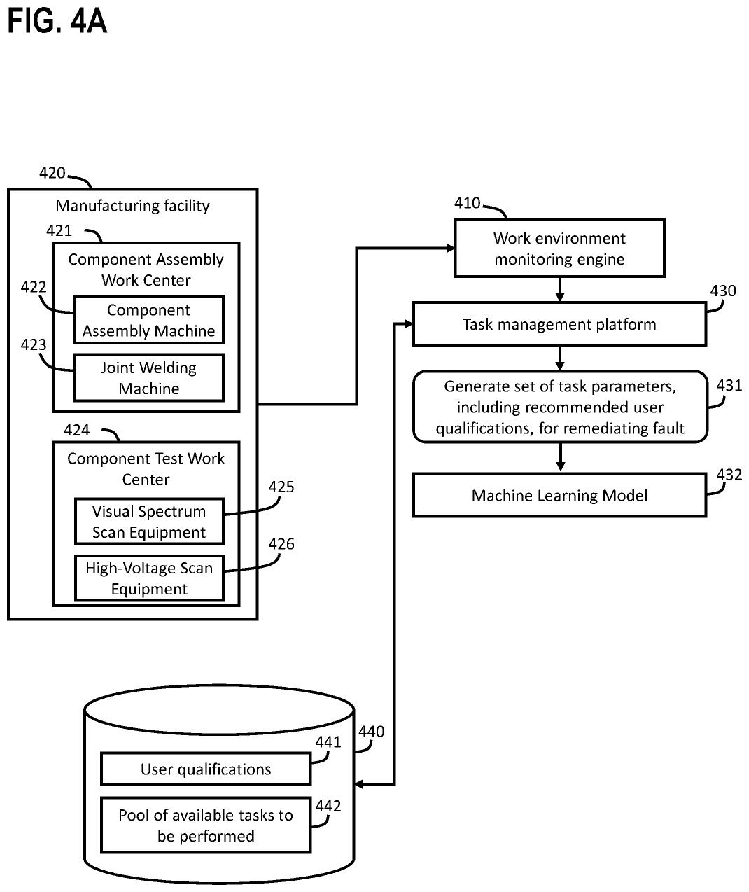

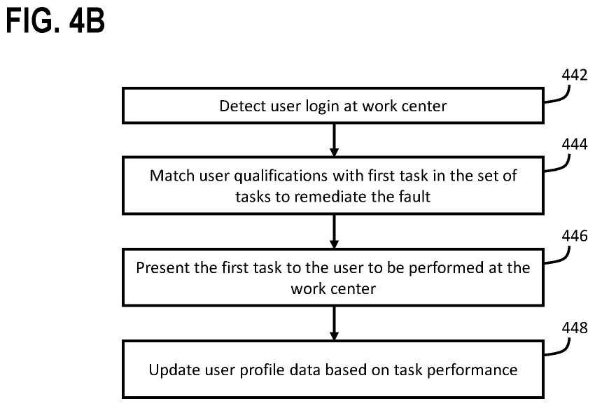

FIGS. 4A-4B illustrate a set of operations for managing tasks presented to users based on matching user qualifications with task requirements, according to one example embodiment.

A work environment monitoring engine 410 monitors work centers 421 and 424 for performance data and fault data. The manufacturing facility 420 includes a component assembly work center 421 and a component test work center 424. Each work center includes a set of equipment for performing particular tasks. For example, the component assembly work center 421 includes a component assembly machine 422 and a joint welding machine 423. The component test work center 424 includes visual spectrum scan equipment 425 and high-voltage scan equipment 426. Multiple users may interact with the equipment in the work centers 421 and 424 to perform tasks. For example, workers may work in shifts. In addition, workers may be assigned to different work centers based on a users' qualifications and equipment availability. In the example illustrated in FIG. 4A, the work environment monitoring engine 410 detects that high-voltage scan equipment 426 in the component test work center 424 is malfunctioning.

A task management platform 430 generates a set of parameters 431 associated with a task for remediating the fault. For example, the task management platform 430 may determine that the equipment 426 is a component-testing device that performs a high-voltage scan of a component to detect flaws in the component. The system may determine that measurements from the component assembly machine 422 are outside a threshold set of ranges for normal operation. Accordingly, the system generates a set of task parameters including: (a) an electrical diagnosis task to be performed on a component assembly machine 422, and (b) user qualifications include a user with experience performing electrical diagnosis of manufacturing or testing equipment. An example set of task parameters may include terms such as: “electrical diagnosis,” “Model C300, C400, or C500 certified,” “high voltage,” “Hazardous,” “Region A4, A5, or A6,” “Work Group C.” The system may generate the parameters based on equipment information associated with a fault, predefined specifications for handling equipment (for example, an enterprise may specify certain training is required to operate the high-voltage scan equipment 426), and scheduling information, such as an estimated time to complete a task.

In the embodiment illustrated in FIG. 4A, the task management platform 430 compares the task parameters 431 with user qualifications 441 stored in a database 440. For example, an organization may store user profile information of employees authorized to work in the manufacturing facility 420. Based on determining that the parameters do not match any user qualifications 441 within a predefined threshold (for example, no user profile description of experience and work history includes a threshold number of matching terms with the task parameters), the task management platform 430 provides the machine learning model 432 with the task parameters 431. The machine learning model 432 generates a recommended set of qualifications corresponding to at least one user with qualifications 441 stored in the database 440. For example, the machine learning model 432 may learn in training that a user with at least three years of experience repairing Model B100-B300 equipment has a high rate of success diagnosing model C300-C500 equipment. Accordingly, the machine learning model 432 may generate an output set of user qualifications including “three years' experience” and “Model B100-B300 certified.”

The work environment monitoring engine 410 generates a task in a task management platform 430. The task management platform 430 stores sets of tasks and matches the tasks to users with particular qualifications.

Referring to FIG. 4B, the task management platform 430 detects a user login at the work center 424 (Operation 442). The task management platform 430 analyzes the user qualifications for the user. For example, the task management platform 430 retrieves the user qualifications 441 for the user from the database 440 and compares the user qualifications 441 to the recommended qualifications for the tasks stored in the task management platform 430. The task management platform 430 matches the user qualifications with the recommended qualifications for remediating the fault in the high-voltage scan equipment 426 (Operation 444). In particular, the task management platform 430 determines that the user profile includes the terms “five years' experience” and “Model B300 certified.” The system further determines that the user's qualifications match two other tasks that are available to be performed at the work center 424. Based on determining that the task to remediate the fault in the equipment 426 is a higher priority than any other tasks, the task management platform 430 presents the task to the user to be performed at the work center 424 (Operation 446). For example, the task management platform 430 may display, on a graphical user interface (GUI) of a display device at the work center 424, a set of operations to be performed by the user to complete the task. The task management platform 430 monitors the completion time of the user to complete the task and updates the user's profile based on the performance of the task (Operation 448). For example, if the task is successfully completed, the task management platform 430 may update the user's profile with the terms “Model C455,” corresponding to the model of the high-voltage scan equipment 426. The task management platform 430 may further update the user's statistics with a completion time for the task. The system may analyze the user's updated statistics and qualifications when determining whether the user's qualifications match subsequently-available tasks.

### 6. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use the same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with the same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with the same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets received from the source device are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 7. MISCELLANEOUS; EXTENSIONS

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 8. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

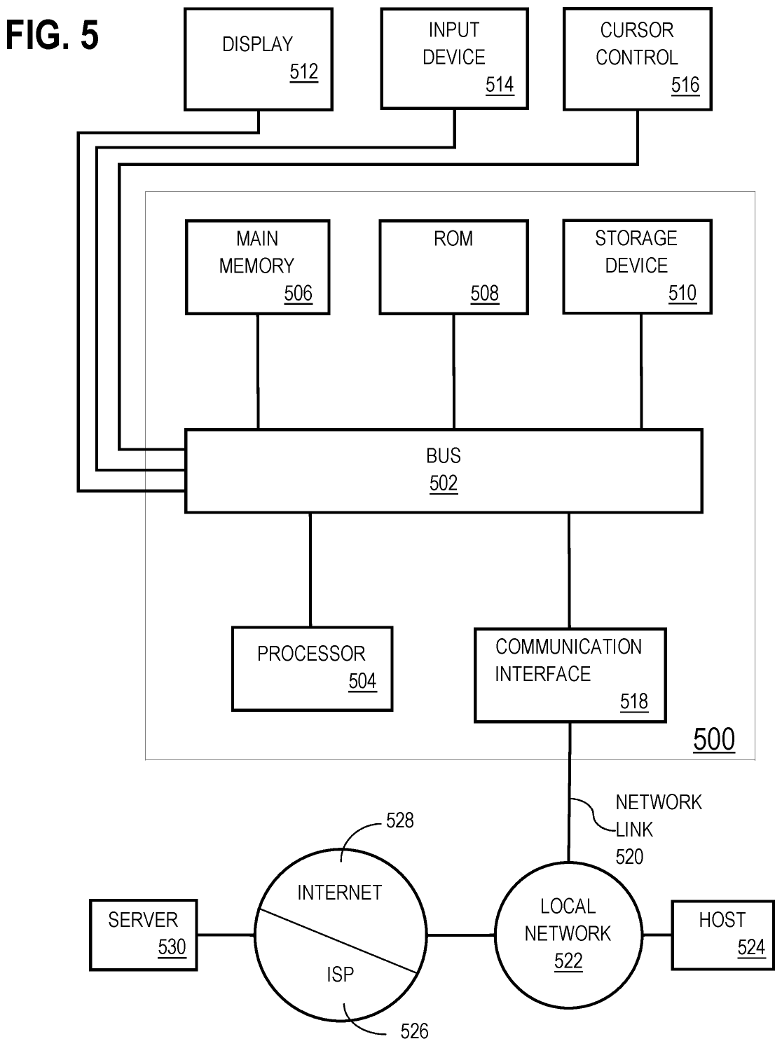

For example, FIG. 5 is a block diagram that illustrates a computer system 500 upon which an embodiment of the invention may be implemented. Computer system 500 includes a bus 502 or other communication mechanism for communicating information, and a hardware processor 504 coupled with bus 502 for processing information. Hardware processor 504 may be, for example, a general-purpose microprocessor.

Computer system 500 also includes a main memory 506, such as a random-access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk or optical disk, is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid-state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world-wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
receiving, from a user terminal, first user identification information associated with a first user;
responsive to receiving the first user identification information: obtaining first user qualification information associated with the first user;
identifying a set of equipment associated with the terminal;
based on the first user qualification information: filtering a set of tasks to generate a first filtered set of tasks to be performed by the first user, wherein each task in the filtered set of tasks includes a user qualification task parameter and an equipment task parameter, wherein the user qualification task parameter corresponds to the first user qualification information, and wherein the equipment task parameter specifies at least one piece of equipment from among the set of equipment associated with the terminal;
receiving, from the terminal, second user identification information associated with a second user;
responsive to receiving the second user identification information: obtaining second user qualification information associated with the second user; and
based on the second user qualification information and the set of equipment associated with the terminal: filtering the set of tasks to generate a second filtered set of tasks to be performed by the second user using the set of equipment,
wherein the second filtered set of tasks is different than the first filtered set of tasks based, at least in part, on a difference between the first user qualification information and the second user qualification information.

2. The non-transitory computer readable medium of claim 1, wherein the operations further comprise:
detecting a fault in a work environment;
responsive to detecting the fault: generating a set of task parameters for a new task, wherein the set of task parameters includes recommended user qualifications to perform the new task; and
storing the new task together with the set of tasks,
wherein the first filtered set of tasks includes the new task, and
wherein filtering the set of tasks to generate the filtered set of tasks includes determining that the first user qualification information matches the recommended user qualifications to perform the new task.

3. The non-transitory computer readable medium of claim 1, wherein the operations further comprise:
monitoring a task-performance status associated with the first user to determine whether the first user has completed a first task among the first filtered set of tasks; and
responsive to determining that the first user has completed the first task among the first filtered set of tasks: updating the first user qualification information in a database to generate updated first user qualification information based on at least one performance metric associated with completion of the first task by the first user, wherein the at least one performance metric specifies a qualitative measure of one or more characteristics associated with the completion of the first task by the first user.

4. The non-transitory computer readable medium of claim 3, wherein the operations further comprise:
based on the updated first user qualification information: filtering the set of tasks to generate a third filtered set of tasks to be performed by the first user, wherein the third filtered set of tasks includes at least one task among the set of tasks that was omitted from the first filtered set of tasks.

5. The non-transitory computer readable medium of claim 1, wherein the operations further comprise:
determining, based on the first user qualification information, whether the first user is qualified to operate each piece of equipment of the set of equipment,
wherein filtering the set of tasks to generate the first filtered set of tasks is responsive to determining that (a) the first user is qualified to operate a first piece of equipment, and (b) the first user is not qualified to operate a second piece of equipment,
wherein the first filtered set of tasks includes at least a first task to be completed with at least the first piece of equipment, and wherein the first filtered set of tasks omits a second task to be completed with at least the second piece of equipment.

6. The non-transitory computer readable medium of claim 1, wherein the operations further comprise:
identifying a second task that requires completion of a first task prior to initiating the second task,
wherein filtering the set of tasks to generate the first filtered set of tasks to be performed by the first user comprises including the first task among the first filtered set of tasks and omitting the second task from among the first filtered set of tasks, and
responsive to determining that the first user has completed the first task: generating a third filtered set of tasks to be performed by the first user, the third filtered set of tasks comprising the second task.

7. The non-transitory computer readable medium of claim 1, wherein the operations further comprise:
applying a machine learning model to a set of task parameters associated with a particular task, wherein the set of task parameters includes: equipment information associated with equipment required to perform the particular task and at least one of:
fault parameters describing characteristics of a fault detected in a work environment including the terminal;
material parameters describing material required to perform the particular task; and
user parameters describing one or more user qualifications required to perform the particular task; and
responsive to applying the machine learning model to the set of task parameters, generating, by the machine learning model, a recommendation corresponding to one or more users for performing the particular task.

8. The non-transitory computer readable medium of claim 1, wherein the operations further comprise:
identifying a set of task parameters for a particular task, wherein the set of task parameters includes a set of user qualifications required to perform the task;
comparing the set of user qualifications to a plurality of sets of user qualifications associated with a plurality of users;
responsive to determining that the set of user qualifications does not meet a threshold similarity level with any of the plurality of sets of user qualifications:
applying a machine learning model to the set of task parameters associated with the particular task; and
responsive to applying the machine learning model to the set of task parameters, generating, by the machine learning model, a recommendation corresponding to one or more recommended user qualifications for performing the particular task.

9. A method comprising:
receiving, from a user terminal, first user identification information associated with a first user;
responsive to receiving the first user identification information: obtaining first user qualification information associated with the first user;
identifying a set of equipment associated with the terminal;
based on the first user qualification information: filtering a set of tasks to generate a first filtered set of tasks to be performed by the first user, wherein each task in the filtered set of tasks includes a user qualification task parameter and an equipment task parameter, wherein the user qualification task parameter corresponds to the first user qualification information, and wherein the equipment task parameter specifies at least one piece of equipment from among the set of equipment associated with the terminal;
receiving, from the terminal, second user identification information associated with a second user;
responsive to receiving the second user identification information: obtaining second user qualification information associated with the second user; and
based on the second user qualification information and the set of equipment associated with the terminal: filtering the set of tasks to generate a second filtered set of tasks to be performed by the second user using the set of equipment,
wherein the second filtered set of tasks is different than the first filtered set of tasks based, at least in part, on a difference between the first user qualification information and the second user qualification information.

10. The method of claim 9, further comprising:
detecting a fault in a work environment;
responsive to detecting the fault: generating a set of task parameters for a new task, wherein the set of task parameters includes recommended user qualifications to perform the new task; and
storing the new task together with the set of tasks,
wherein the first filtered set of tasks includes the new task, and
wherein filtering the set of tasks to generate the filtered set of tasks includes determining that the first user qualification information matches the recommended user qualifications to perform the new task.

11. The method of claim 9, further comprising:
monitoring a task-performance status associated with the first user to determine whether the first user has completed a first task among the first filtered set of tasks; and
responsive to determining that the first user has completed the first task among the first filtered set of tasks: updating the first user qualification information in a database to generate updated first user qualification information based on at least one performance metric associated with completion of the first task by the first user, wherein the at least one performance metric specifies a qualitative measure of one or more characteristics associated with the completion of the first task by the first user.

12. The method of claim 11, further comprising:
based on the updated first user qualification information: filtering the set of tasks to generate a third filtered set of tasks to be performed by the first user, wherein the third filtered set of tasks includes at least one task among the set of tasks that was omitted from the first filtered set of tasks.

13. The method of claim 9, further comprising:
determining, based on the first user qualification information, whether the first user is qualified to operate each piece of equipment of the set of equipment,
wherein filtering the set of tasks to generate the first filtered set of tasks is responsive to determining that (a) the first user is qualified to operate a first piece of equipment, and (b) the first user is not qualified to operate a second piece of equipment,
wherein the first filtered set of tasks includes at least a first task to be completed with at least the first piece of equipment, and wherein the first filtered set of tasks omits a second task to be completed with at least the second piece of equipment.

14. The method of claim 9, further comprising:
identifying a second task that requires completion of a first task prior to initiating the second task,
wherein filtering the set of tasks to generate the first filtered set of tasks to be performed by the first user comprises including the first task among the first filtered set of tasks and omitting the second task from among the first filtered set of tasks, and
responsive to determining that the first user has completed the first task: generating a third filtered set of tasks to be performed by the first user, the third filtered set of tasks comprising the second task.

15. The method of claim 9, further comprising:
applying a machine learning model to a set of task parameters associated with a particular task, wherein the set of task parameters includes: equipment information associated with equipment required to perform the particular task and at least one of:
fault parameters describing characteristics of a fault detected in a work environment including the terminal;
material parameters describing material required to perform the particular task; and
user parameters describing one or more user qualifications required to perform the particular task; and
responsive to applying the machine learning model to the set of task parameters, generating, by the machine learning model, a recommendation corresponding to one or more users for performing the particular task.

16. The method of claim 9, further comprising:
identifying a set of task parameters for a particular task, wherein the set of task parameters includes a set of user qualifications required to perform the task;
comparing the set of user qualifications to a plurality of sets of user qualifications associated with a plurality of users;
responsive to determining that the set of user qualifications does not meet a threshold similarity level with any of the plurality of sets of user qualifications:
applying a machine learning model to the set of task parameters associated with the particular task; and
responsive to applying the machine learning model to the set of task parameters, generating, by the machine learning model, a recommendation corresponding to one or more recommended user qualifications for performing the particular task.

17. A system comprising:
one or more processors; and
memory storing instructions that, when executed by the one or more processors, cause the system to perform operations comprising:
receiving, from a user terminal, first user identification information associated with a first user;
responsive to receiving the first user identification information: obtaining first user qualification information associated with the first user;
identifying a set of equipment associated with the terminal;
based on the first user qualification information: filtering a set of tasks to generate a first filtered set of tasks to be performed by the first user, wherein each task in the filtered set of tasks includes a user qualification task parameter and an equipment task parameter, wherein the user qualification task parameter corresponds to the first user qualification information, and wherein the equipment task parameter specifies at least one piece of equipment from among the set of equipment associated with the terminal;
receiving, from the terminal, second user identification information associated with a second user;
responsive to receiving the second user identification information: obtaining second user qualification information associated with the second user; and
based on the second user qualification information and the set of equipment associated with the terminal: filtering the set of tasks to generate a second filtered set of tasks to be performed by the second user using the set of equipment,
wherein the second filtered set of tasks is different than the first filtered set of tasks based, at least in part, on a difference between the first user qualification information and the second user qualification information.

18. The system of claim 17, wherein the operations further comprise:
detecting a fault in a work environment;
responsive to detecting the fault: generating a set of task parameters for a new task, wherein the set of task parameters includes recommended user qualifications to perform the new task; and
storing the new task together with the set of tasks,
wherein the first filtered set of tasks includes the new task, and
wherein filtering the set of tasks to generate the filtered set of tasks includes determining that the first user qualification information matches the recommended user qualifications to perform the new task.

19. The system of claim 17, wherein the operation further comprise:
monitoring a task-performance status associated with the first user to determine whether the first user has completed a first task among the first filtered set of tasks; and
responsive to determining that the first user has completed the first task among the first filtered set of tasks: updating the first user qualification information in a database to generate updated first user qualification information based on at least one performance metric associated with completion of the first task by the first user, wherein the at least one performance metric specifies a qualitative measure of one or more characteristics associated with the completion of the first task by the first user.

20. The system of claim 19, wherein the operations further comprise:
based on the updated first user qualification information: filtering the set of tasks to generate a third filtered set of tasks to be performed by the first user, wherein the third filtered set of tasks includes at least one task among the set of tasks that was omitted from the first filtered set of tasks.
